(19) United States
(12) Patent Application Publication
(10) Pub. No.: US 2026/0198420 A1
(43) Pub. Date: Jul. 16, 2026

(54) BYPASS SYSTEM FOR DETERMINING SEPARATOR GRAIN LOSS

(71) Applicant: Deere & Company, Moline, IL (US)

(72) Inventor: Nathan R. Vandike, Geneseo, IL (US)

(21) Appl. No.: 19/016,615

(22) Filed: Jan. 10, 2025

(51) Int. Cl. A01D 41/127

(52) U.S. Cl. CPC A01D 41/127

(57) ABSTRACT

A bypass system is provided for receiving a processed crop material from a separator section of a threshing assembly of an agricultural machine. The bypass system can include a housing having a channel through which processed crop material can flow through the bypass system. An inlet to the channel can be at least partially defined by a portion of the housing that is positioned against a grate of the separator section. The bypass system can also include a contact or non-contact sensor that can be configured to capture information of at least a portion of the processed crop material within the channel. The bypass system can also include either or both a compliant body positioned upstream of the sensor, and a conveyor positioned downstream of the sensor. The conveyor can be configured to facilitate a movement of processed crop material located in the channel through at least the outlet.

### FIELD OF THE DISCLOSURE

The present disclosure generally relates to crop loss detection, and, more specifically, to detection and quantification of crop lost from a separator of a harvester.

### BACKGROUND

Agricultural machines can include agricultural and construction vehicles and equipment, as well as combinations thereof, that are used to perform different agricultural and industrial tasks. For example, one or more agricultural machines, including, but not limited to harvesters and windrowers, can be utilized to plant crops, harvest crops, bale or otherwise collect crops, and spray or distribute crop inputs, such as, for example, fertilizer or chemicals, over a field or plants within a field.

### SUMMARY

The present disclosure can comprise one or more of the following features and combinations thereof.

In one embodiment of the present disclosure, a bypass system is provided for receiving a processed crop material from a separator section of a threshing assembly of an agricultural machine. The bypass system can include a housing including an inlet, an outlet, and a channel, the inlet and the outlet being at opposing ends of the channel. The inlet can be configured to provide an opening to receive the processed crop material from the separator section and deliver the processed crop into the channel. The channel can be configured to accommodate a passage of the processed crop material through the bypass system. The bypass system can also include a sensor that can be configured to capture information of at least a portion of the processed crop material within the channel. Additionally, the bypass system can include a conveyor that can be positioned downstream of the sensor, the conveyor being configured to provide a force that facilitates a movement of processed crop material located in the channel through the outlet.

In another embodiment of the present disclosure, a bypass system is provided for receiving a processed crop material from a separator section of a threshing assembly of an agricultural machine. The bypass system can include a housing including an inlet, an outlet, and a channel, the inlet and the outlet being at opposing ends of the channel. The inlet can be configured to provide an opening to receive the processed crop material from the separator section. Additionally, the inlet can be at least partially defined by an arm portion of the housing that is positioned against a grate of the separator section. The channel can be configured to accommodate a passage of the processed crop material through the bypass system. The bypass system can also include a sensor that can be configured to capture information of at least a portion of the processed crop material within the channel.

In another embodiment of the present disclosure, a bypass system is provided for receiving a processed crop material from a separator section of a threshing assembly of an agricultural machine, The bypass system can include a housing including an inlet, an outlet, and a channel, the inlet and the outlet being at opposing ends of the channel. The inlet can be configured to provide an opening to receive the processed crop material from the separator section and deliver the processed crop into the channel. The channel can be configured to accommodate a passage of the processed crop material through the bypass system. The bypass system can also include a sensor that can be configured to capture information of at least a portion of the processed crop material within the channel. Additionally, the bypass system can include a compliant body positioned within the channel. The compliant body can be configured to absorb at least a portion of an impact force from an impact of at least a portion of the processed crop material received into the channel with the compliant body in a manner that, relative to the impact instead being with the housing, reduces at least a directional component of a subsequent travel of the portion of the processed crop material after the impact with the compliant body.

These and other features of the present disclosure will become more apparent from the following description of the illustrative embodiments.

### BRIEF DESCRIPTION OF THE DRAWINGS

The disclosure contained herein is illustrated by way of example and not by way of limitation in the accompanying figures. For simplicity and clarity of illustration, elements illustrated in the figures are not necessarily drawn to scale. For example, the dimensions of some elements can be exaggerated relative to other elements for clarity. Further, where considered appropriate, reference labels have been repeated among the figures to indicate corresponding or analogous elements.

FIG. 1 illustrates a partial cutaway side view of an exemplary agricultural machine in the form of a harvester.

FIG. 2 illustrates a side view of a portion of an exemplary threshing assembly having a bypass system.

FIG. 3 illustrates a front perspective view of a portion of a threshing assembly having dual rotors and a plurality of bypass systems.

FIG. 4 illustrates a side perspective view of a portion of a grate assembly.

FIG. 5 illustrates a partial cutaway side perspective view of a portion of an exemplary threshing assembly having a bypass system.

FIG. 6 illustrates a simplified sectional view of representation of a threshing assembly having a bypass system that includes a sensor mounted to an outer wall of a housing of the bypass system.

FIG. 7 illustrates a simplified sectional view of another embodiment of the bypass system that includes an arm portion that is configured to facilitate the collection of processed crop material that is delivered into the bypass system.

FIGS. 8 and 9 illustrate simplified side view representations of additional embodiments of the bypass system and further illustrate different sized grate openings being adjacent an inlet of the bypass system.

FIG. 10 illustrates simplified side views of other exemplary embodiments of the bypass system in which the arm portion has different angular orientations relative to at least a longitudinal axis of an adjacent rotor assembly.

FIGS. 11 and 12 illustrate simplified representations of other exemplary embodiments of the bypass system that include inlets of different sizes and angular positions.

FIG. 13 illustrates a simplified sectional view of another embodiment of the bypass system.

FIG. 14 illustrates a simplified sectional view of another embodiment of the bypass system having a sensor is mounted at a location at which the sensor can be contacted by processed crop material flowing through a channel of the bypass system.

FIG. 15 illustrates a simplified sectional view of another exemplary embodiment of the bypass system that includes a conveyance system for at least conveying processed crop material through an outlet of the bypass system.

Corresponding reference numerals are used to indicate corresponding parts throughout the several views.

### DETAILED DESCRIPTION

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described can include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

In the drawings, some structural or method features may be shown in specific arrangements or orderings. However, it should be appreciated that such specific arrangements and orderings may not be required. Rather, in some embodiments, such features may be arranged in a different manner or order than shown in the illustrative figures. Additionally, the inclusion of a structural or method feature in a particular figure is not meant to imply that such feature is required in all embodiments and, in some embodiments, may not be included or may be combined with other features.

Embodiments of the subject disclosure provide a bypass system that can be positioned and configured to receive at least a portion of processed harvested crop material, including crop and materials other than crop, such as, for example, straw, chaff, and debris, among other materials, that pass out of a separator section of a threshing assembly of an agricultural machine. The bypass system can, relative to other areas within the threshing assembly, be configured to provide a relatively cleaner area for at least some processed crop material released from the separator section to flow before moving to another portion of the agricultural machine, such as, for example, to a cleaning shoe. Additionally, the bypass system can include a sensor, such as, for example, a camera, that can capture information of at least a portion of the crop material flowing through the bypass system. The relatively cleaner area provided by the bypass system can improve the quality of information, including, for example, either images or videos, captured by the sensor of the processed crop material flowing through the bypass system. Such improved quality of the captured information can enhance the accuracy of determinations made using the captured information, including, for example, determinations relating to the quantity of crop (e.g., grain) exiting the separator section. As discussed below, such determinations can further facilitate enhancements in modifications, if any, made to the operation of the agricultural machine, including to the threshing assembly, to reduce the quantity of crop passing through the separator section. Additionally, as discussed below, the bypass system can be configured to assist with positioning the sensor in a manner that prevents debris, including, for example, rocks, released from the separator section directly contacting the sensor, or facilitates the debris contacting the sensor after a speed of travel of the debris has been reduced.

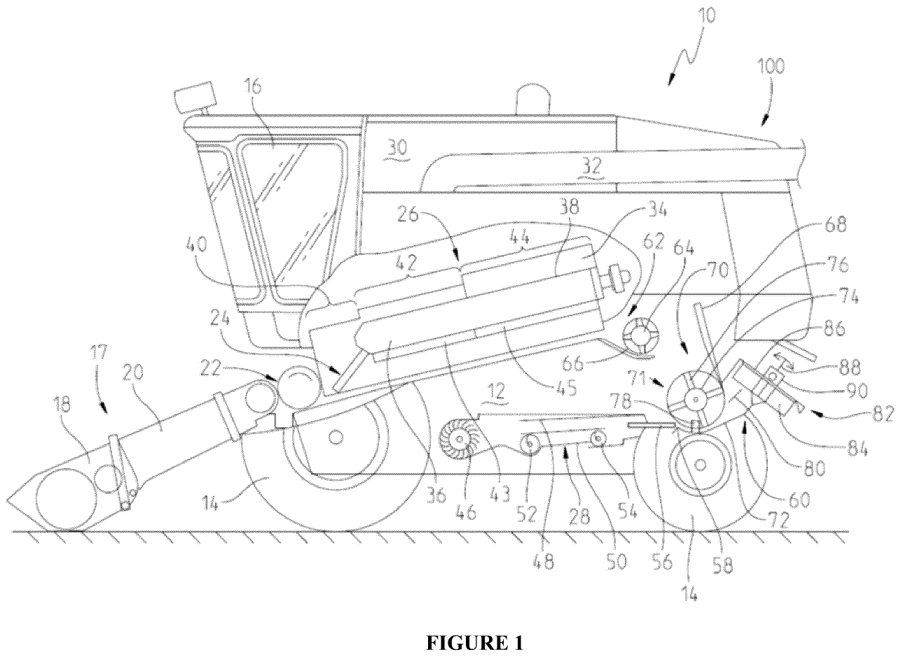

In FIG. 1, an embodiment of an agricultural machine 10 is shown. The agricultural machine 10 includes a frame 12 and one or more ground engaging mechanisms, such as wheels 14 or tracks, which are in contact with an underlying ground surface. In the illustrative embodiment, the wheels 14 are coupled to the frame 12 and are used for propulsion of the agricultural machine 10 in a forward operating direction (which is to the left in FIG. 1) and in other directions. In some embodiments, operation of the agricultural machine 10 is controlled from an operator cab 16. The operator cab 16 can include any number of controls for controlling the operation of the agricultural machine 10, such as a user interface. In some embodiments, operation of the agricultural machine 10 can be conducted by a human operator in the operator cab 16, a remote human operator, or an automated system. Thus, according to certain embodiments, the agricultural machine 10 can be an autonomous or semi-autonomous vehicle. Moreover, according to certain embodiments, the agricultural machine 10 can be, or be operated, as an unmanned vehicle. Thus, according to certain embodiments, the agricultural machine 10 may not include an operator cab 16.

The agricultural machine 10 can also include an agricultural system 100. For example, as mentioned above, the illustrated agricultural machine 10 is a harvester. Thus, the agricultural system 100 can comprise a plurality of components, or subsystems, relating to the agricultural machine 10 performing an agricultural operation at least in the form of harvesting crops. Thus, the agricultural systems for different types of agricultural machines 10 can be configured, including having components or subsystems, for the particular agricultural operation(s) that is/are to be performed by that agricultural machine 10. For example, the agricultural system 100 of an agricultural machine 10 in the form of a windrower can be configured to perform agricultural operations at least relating to the formation of windrows.

With respect to the exemplary agricultural machine 10 depicted in FIG. 1, the agricultural system 100 can include a header 17 having a cutting head 18 disposed at a forward end of the agricultural machine 10 and used to harvest crop (such as corn) and conduct the harvested crop to a slope conveyor 20 of the header 17. The slope conveyor 20 conducts the harvested crop to a guide drum 22. The guide drum 22 of the agricultural system 100 guides the harvested crop to an inlet 24 of a threshing assembly 26, as shown in FIG. 1. The threshing assembly 26 of the agricultural system 100 includes a housing 34 and one or more threshing rotors. A single threshing rotor 36 is shown in FIG. 1, and the threshing rotor 36 includes a drum 38. The threshing assembly 26 includes a charging section 40, a threshing section 42, and a separator section 44. The charging section 40 is arranged at a front end of the threshing assembly 26, the separator section 44 is arranged at a rear end of the threshing assembly 26, and the threshing section 42 is arranged between the charging section 40 and the separator section 44.

Harvested crop that includes grain, such as corn, and material other than grain (MOG) falls through a thresher basket 43 positioned in the threshing section 42 and through a separating grate 45 positioned in the separator section 44. The harvested crop can be directed to a clean crop routing assembly 28 with a blower 46 and sieves 48, 50 with louvers. The sieves 48, 50 can be oscillated in a fore-and-aft direction. The clean crop routing assembly 28 of the agricultural system 100 removes the MOG and guides grain over a screw conveyor 52 to an elevator for grain. The elevator for grain deposits the grain in a grain tank 30 of the agricultural system 100, as shown in FIG. 1. The grain in the grain tank 30 can be unloaded by means of an unloading screw conveyor 32 to a grain wagon, trailer, or truck, for example.

Harvested crop remaining at an end of the sieve 50 is again transported to the threshing assembly 26 by a screw conveyor 54 where it is reprocessed by the threshing assembly 26. Harvested crop delivered at an end of the sieve 48 is conveyed by an oscillating sheet conveyor 56 to a lower inlet 58 of a crop debris routing assembly 60. Harvested crop at the threshing assembly 26 is processed by the separator section 44 resulting in straw being separated from other material of the harvested crop. The straw is ejected through an outlet 62 of the threshing assembly 26 and conducted to an ejection drum 64. The ejection drum 64 interacts with a sheet 66 arranged underneath the ejection drum 64 to move the straw rearwardly. A wall 68 is located to the rear of the ejection drum 64 and guides the straw into an upper inlet 70 of the crop debris routing assembly 60.

The crop debris routing assembly 60 of the agricultural system 100 includes a chopper assembly 71 having a chopper housing 72 and a chopper rotor 74 arranged in the chopper housing 72 that rotates, for example, in a counterclockwise direction about an axis that extends, for example, perpendicular to the forward operating direction. The chopper rotor 74 includes a plurality of chopper knives 76 that are distributed around a circumference of the chopper rotor 74. The chopper knives 76 interact with opposing knives 78, which are, for example, coupled to the chopper housing 72. The chopper knives 76 and the opposing knives 78 cooperate to chop the straw into smaller pieces.

The illustrated agricultural system 100 also includes one or more spreaders downstream of an outlet 80 of the crop debris routing assembly 60. One spreader 82 is shown in FIG. 1. The spreader 82 may include a number of impeller blades 84, each of which is connected to a disk 86 that rotates about a central axis 88. The impeller blades 84 extend downwardly from the disk 86 and, for example, radially outwardly from the central axis 88. The disk 86 and the impeller blades 84 coupled thereto are rotatably driven by a hydraulic motor 90. Chopped straw is moved through the outlet 80 of the crop debris routing assembly 60 to the spreader 82. Rotation of the impeller blades 84 of the spreader 82 spreads the chopped straw as it exits the agricultural machine 10.

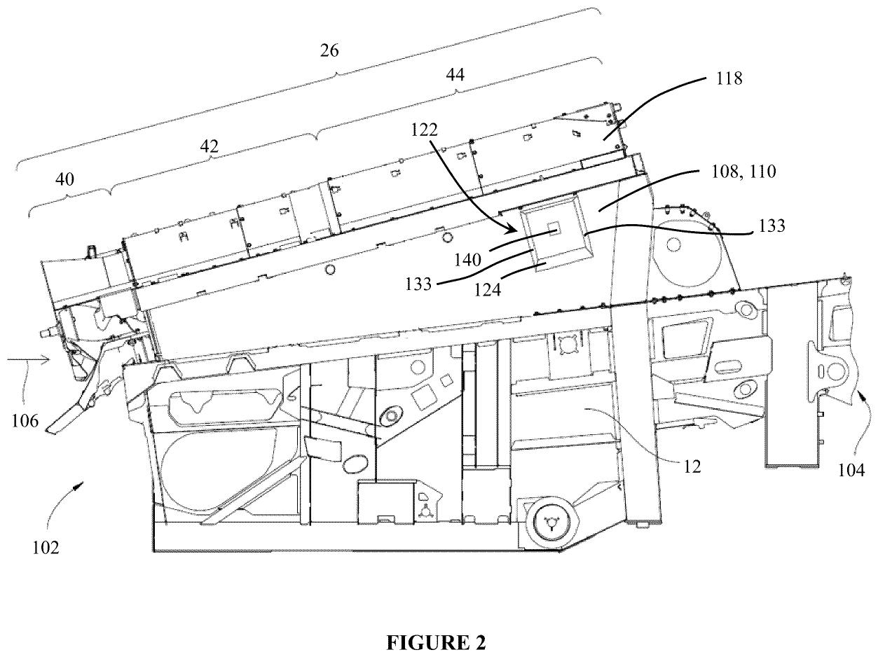

FIG. 2 illustrates a portion of an internal area within the agricultural machine 10 that includes the threshing assembly 26. In the illustrated example, the threshing assembly 26 can include the charging section 40 located towards a front 102 of the threshing assembly 26, with the separator section 44 being located towards a rear 104 of the threshing assembly 26. The threshing section 42 can be located between the charging section 40 and the separator section 44. Crop collected by the agricultural machine 10 can be forced in a rearward direction, as indicated by arrow 106 in FIG. 2, through at least the threshing section 42 and separator section 44. The agricultural machine 10 can also include an enclosure 108 positioned and configured to prevent or reduce the amount of crop that can inadvertently escape from within the threshing assembly 26. Thus, for, example, at least a portion of the enclosure 108, such as, for example, one or more sidewalls 110, can define at least a portion of an interior area 120 of the enclosure 108 and extend along either or both the threshing section 42 and the separator section 44, including at least partially span along either or both the threshing section 42 and separator section 44.

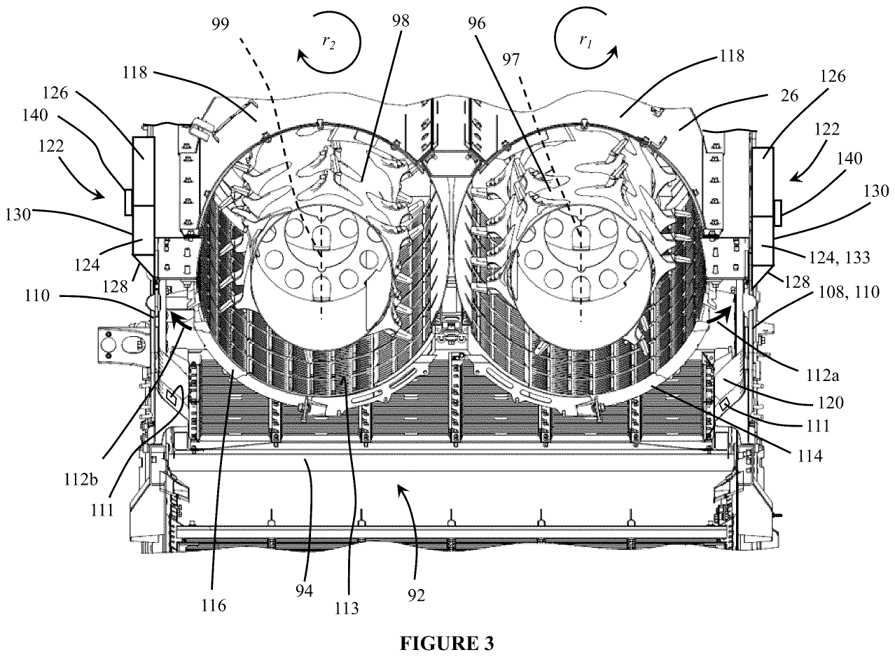

FIG. 3 illustrates a portion of an exemplary, dual rotor threshing assembly 26. More specifically, FIG. 3 illustrates a threshing assembly 26 having a first rotor assembly 96 and an adjacent second rotor assembly 98. While FIG. 3 illustrates a dual rotor threshing assembly 26, embodiments of the subject disclosure can be utilized with other types of threshing assemblies, including, but not limited to, single rotor threshing assemblies. In the illustrated embodiment, the first rotor assembly 96 can define a first longitudinal axis 97 about which the first rotor assembly 96 rotates in a first rotational direction (as generally indicated by “r₁” in FIG. 3), and the second rotor assembly 98 can define a second longitudinal axis 99 about which the second rotor assembly 98 rotates in an opposite, second rotational direction (as generally indicated by “r₂” in FIG. 3).

The threshing assembly 26 can include an assembly cover 118 and one or more grate assemblies 114, 116 that are disposed adjacent to the first and second rotor assemblies 96, 98. The assembly cover 118 is positioned above the grate assemblies 114, 116 and can be configured to not allow the processed crop material to pass through the assembly covers 118. Conversely, the grate assemblies 114, 116 are positioned beneath the first and second rotor assemblies 96, 98 and include a plurality of openings through which crop and MOG from the processed crop material can fall through the threshing assembly 26 and into the cleaning shoe 92. Although two grate assemblies 114, 116 are illustrated, the threshing assembly 26 can include additional or fewer grate assemblies 114, 116. Further, the grate assemblies 114, 116 are provided in at least the separator section 44 of the threshing assembly 26, and can be included with, or form part of, a concave.

As the crop material being processed travels along at least a portion of the threshing assembly 26, the first and second rotor assemblies 96, 98, in combination with the grate assemblies 114, 116, operate to separate crop, such as, for example, grain, among others, from the harvested crop material. Moreover, the grate assemblies 114, 116 and respective first and second rotor assemblies 96, 98 cooperate to thresh or separate harvested crop material. As shown in at least FIG. 3, at least a portion of the first grate assembly 114 is curved and, in some instances, conforms to a cylindrical shape of the first rotor assembly 96. Similarly, at least a portion of the grate assembly 116 is curved and, in some instances, conforms to the cylindrical shape of the second rotor assembly 98. Thus, at least a portion of the first and second rotor assemblies 96, 98 can nest within the curvature of grate assemblies 114, 116, respectively. According to such a configuration, the conforming shapes of the grate assemblies 114, 116 and the close proximity of the grate assemblies 114, 116 to the respective first and second rotor assemblies 96, 98 can provide for threshing or separating of harvested crop material.

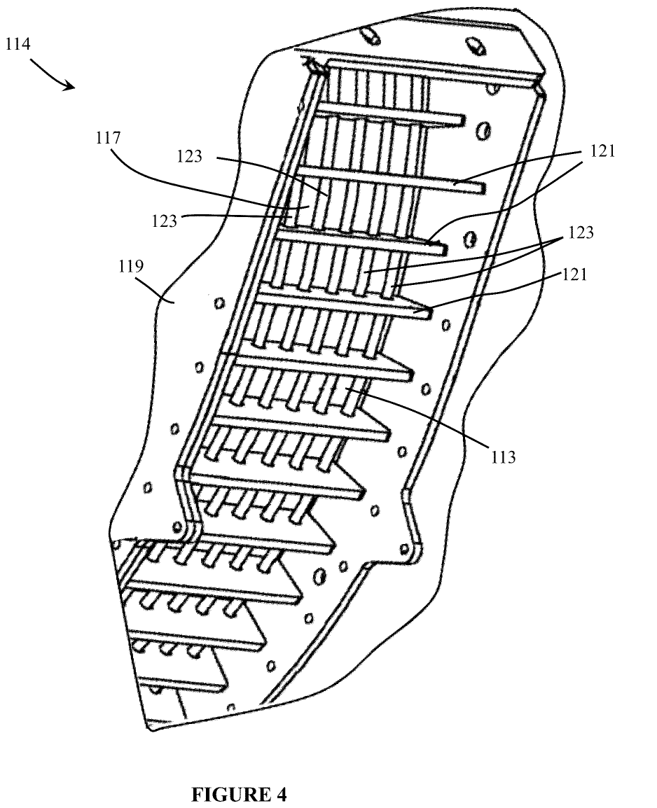

FIG. 4 illustrates a side perspective view of a portion of an exemplary grate assembly 114. The grate assembly 114 can include a grate 113 having one or more arc shaped sidewalls 119 that can be generally curved so as to follow a contour, e.g., a cross-sectional circular shape, of the adjacent first rotor assembly 96, and, moreover, have an arc shape that can be defined by a radius extending from an axis that can be aligned or shared with the corresponding first or second longitudinal axis 97, 99. Additionally, a plurality of crossbars 121 can extend longitudinally from the adjacent sidewall 119, including between opposing sidewalls 119. The crossbars 121 can be generally perpendicular to the adjacent sidewall(s) 119, as well as offset from other crossbars 121 so as to provide spacing between the crossbars 121. Further, a plurality of fingers 123 can extend between adjacent crossbars 121 while also being spaced from other adjacent fingers 123. Moreover, the grate 113 can include a plurality of openings 117, each opening being defined by a pair of adjacent fingers 123 and by a portion of opposing crossbars 121, as seen in FIG. 4. Thus, the openings 117 can generally have a width that can be based on a distance between adjacent fingers 123, and a height that can be defined by a distance between the corresponding crossbars 121. Further, the shape, including cross-sectional shape, of the openings 117 can be generally defined by the positioning and/or configuration of the crossbars 121 and fingers 123. Thus, while FIG. 4 illustrates a plurality of openings 117 having generally rectangular cross sectional shapes, the openings 117 can have a variety of other shapes. Additionally, while FIG. 4 illustrates a plurality of openings 117 being enclosed on the sides by the crossbars 121 and fingers 123, according to other embodiments, the openings 117 can have a partially open configuration, such as, for example by at least one finger 123 not extending to both of the corresponding crossbars 121.

According to certain embodiments, a rotational force can be imparted onto the crop material undergoing processing, also referred to herein as processed crop material, within the threshing assembly 26 by the rotating rotor assemblies 96, 98. Such rotational forces can result in at least a portion of the MOG and crop, including crop separated from MOG and crop entrained in or with the MOG in the processed crop material, being discharged through the openings 117 of the grate assembly 114, 116 of the separator section 44 along one or more trajectories 112a, 112b, as shown, for example, in FIG. 3. Thus, processed crop material released through the openings 117 of the grate assembly 114, 116 can follow a trajectory 112a, 112b having at least one, if not both, a vertical component and a horizontal component.

At least some of the processed crop material discharged through at least some of the openings 117 may therefore travel along a trajectory(ies) 112a, 112b generally toward at least a portion of a return pan 94 of the cleaning shoe 92. As seen in at least FIG. 3, the return pan 94 can be positioned below the rotor assemblies 96, 98, including below, and partially rearward of, the threshing assembly 26. The return pan 94, which can be part of the cleaning shoe 92, can be configured to facilitate the discharged processed crop material being conveyed in a generally forward direction, and, moreover, in a direction that is generally opposite the rearward direction 106, so that the discharged processed crop material on the return pan 94 can spend more time in the cleaning shoe 92 as the processed crop material is subsequently directed in the rearward direction 106 along one or more chaffers or sieves 95 below the return pan 94. Additionally, or alternatively, the trajectory(ies) 112a, 112b of at least some processed crop material discharged through at least some of the openings 117 may result in processed crop material being directed toward, and hitting, various portions of an adjacent sidewall 110 of the enclosure 108.

According to certain embodiments, the threshing assembly 26 can include one or more strike or impact sensors 111 positioned adjacent to at least the separator section 44 of the threshing assembly 26. For example, according to certain embodiments, the impact sensors 111 can be positioned along one or more sidewalls 110 within the interior area 120 of the enclosure 108. The impact sensors 111, which can, for example, be piezoelectric sensing elements, among others, can be used in generating estimates as to the extent of crop loss, including grain loss. Moreover, such sensors can be positioned adjacent to the separator section 44 and configured to detect when crop, such as, for example, a seed, within the flow of processed crop material that has exited the separator section 44 hits or strikes the impact sensor(s) 111. The number of hits or strikes of the crop against the impact sensor(s) 111, including, for example, a number of strikes within a predetermined time period, can be correlated, such as, for example, via a transfer function, to an amount of crop dispensed from the separator section 44 to determine the crop loss from either or both the threshing assembly 26 or the separator section 44.

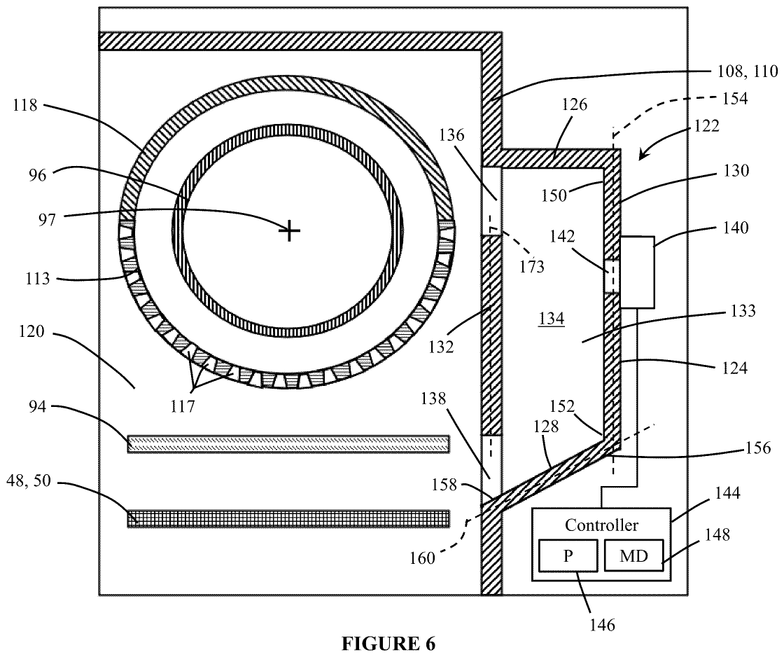

In at least certain instances, at least some of the MOG included in the processed crop material exiting the separator section 44 can have a size, including weight, similar to crop that can also be in the processed crop material. Further, in such instances, in the event such similarly sized MOG hits or impacts the impact sensor 111, the signal generated by the impact sensor 111 can be similar to, or within an anticipated range of, signals corresponding to crop striking the impact sensor 111. Thus, such similarities in signals may present challenges to the extent a controller 144 (FIG. 6) can, or cannot, distinguish information from the impact sensor 111 as corresponding to either a strike by crop or by MOG, which can adversely impact the ability to accurately determine, including estimate, the amount of crop that may be flowing out from the separator section 44 with the discharged processed crop material.

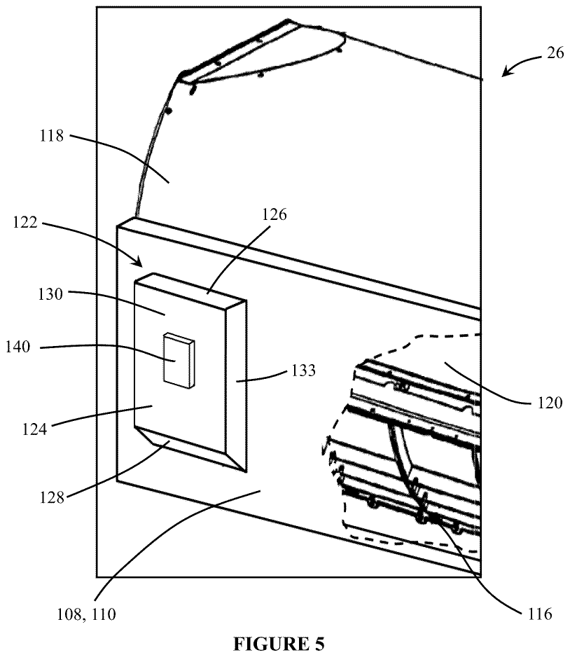

As seen in each of FIGS. 2, 3, and 5, the illustrated threshing assembly 26, or portion thereof, can include one or more bypass systems 122. The bypass system(s) 122 can be configured to redirect a flow of the processed crop material discharged from the separator section 44, including redirect the discharged processed crop material into the bypass system 122. Moreover, the bypass system 122 can be configured to allow at least a certain portion of processed crop material, including crop (e.g., grain) and MOG discharged from the separator section 44 to flow into a channel 134 within the bypass system 122, wherein the bypassed flow of processed crop material can flow either or both by and into a contact or non-contact sensor 140 of the bypass system 122. Thus, according to certain embodiments, the bypass system 122 can be configured to minimize the ability of the processed crop material that flows into, and through, the bypass system 122 from directly impacting or hitting the sensor 140. The sensor 140 can be configured to capture, including collect, information regarding at least the processed crop material flowing through the bypass system 122 that can be used by the controller 144 to determine a composition of the processed crop material, including determining an extent, amount, or ratio of crop (e.g., grain) that is, or is not, present, within the bypassed flow of the discharged processed crop material.

FIG. 6 illustrates a simplified sectional view of an exemplary embodiment of a bypass system 122 coupled to an enclosure 108 of the threshing assembly 26. According to the illustrated embodiment, the housing 124 of the bypass system 122 can extend from the enclosure 108, or otherwise be separated from, including outside of, either or both the interior area 120 and an adjacent sidewall 110 of the enclosure 108. Alternatively, according to other embodiments, the housing 124 of the bypass system 122 can be housed within the enclosure 108.

According to certain embodiments, the housing 124 can include a top wall 126 and an opposing bottom wall 128, an outer wall 130 and an opposing inner wall 132, and sidewalls 133 extending between at least the outer and inner walls 130, 132. Further, according to certain embodiments, at least one of the inner wall 132 and the outer wall 130 of the housing 124 can be provided by at least a portion of the enclosure 108, including, for example, a sidewall 110 of the enclosure 108. The housing 124 of the bypass system 122 can include a top wall 126, bottom wall 128, outer wall 130, and at least a portion of the enclosure 108, or, alternatively, an inner wall. While the housing 124 and enclosure 108 are shown in FIG. 6 as being part of a monolithic or unitary structure, according to other embodiments, at least a portion, if not all, of the housing 124 and the enclosure 108 can be separate structures. Additionally, the enclosure 108 and housing 124 can each be constructed from a variety of materials, including, but not limited to, metal or steel, among others.

The top wall 126, bottom wall 128, outer wall 130, inner wall 132, and sidewalls 133 of the housing 124 can generally define at least a portion of one or more channels 134 that can extend through at least a portion of the bypass system 122, and which can be in fluid communication with the interior area 120 of the enclosure 108. The channel(s) 134 can provide an area or passageway for processed crop material received by the bypass system 122 from the threshing assembly 26, and, more specifically, from the separator section 44, to flow through the bypass system 122.

In the embodiment shown in FIG. 6, the outer wall 130 can extend along a first central axis 154 between first and second ends 150, 152 of the outer wall 130. The first end 150 can be coupled to the top wall 126, and the second end 152 can be coupled to the bottom wall 128. As also seen in FIG. 6, according to certain embodiments, the first central axis 154 of the outer wall 130 can be generally parallel, or, alternatively, non-parallel, to at least a portion of the inner wall 132, which, in this embodiment, is at least in part, a portion of the adjacent sidewall 110 of the enclosure 108.

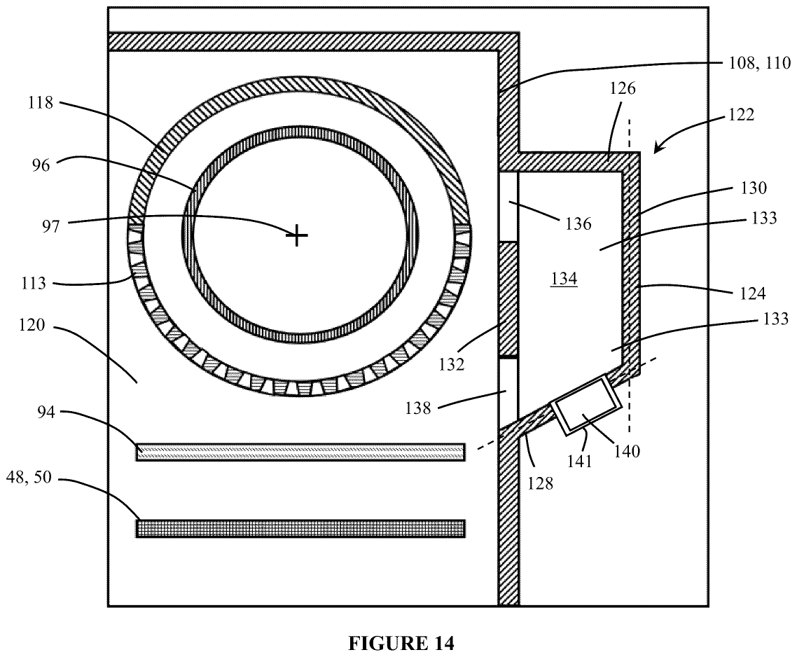

As also seen in FIG. 6, according to certain embodiments, the bottom wall 128 can extend along a second central axis 160 between first and second ends 156, 158 of the bottom wall 128. The first end 156 can be coupled to the second end 152 of the outer wall 130, and the second end 158 of the bottom wall 128 can be coupled to the inner wall 132, or the adjacent sidewall 110 of the enclosure 108. According to certain embodiments, the second central axis 160 of the bottom wall 128 can be generally non-parallel and non-perpendicular to at least the first central axis 154. For example, as seen in at least FIG. 6, according to certain embodiments, the bottom wall 128 can be generally downwardly sloped from the outer wall 130 to the inner wall 132 so as to provide a ramp that can facilitate a movement, such as, for example, a sliding, of processed crop material along the bottom wall 128 to an outlet 138 of the bypass system 122. Conversely, as seen in FIG. 14, according to other embodiments, the second central axis 160 of the bottom wall 128 can be generally perpendicular to the first central axis 154 of the outer wall 130.

As previously discussed, according to certain embodiments, at least a portion of the inner wall 132 can be provided by an adjacent sidewall 110 of the enclosure 108, or, alternatively, can be a separate wall that can be positioned outside of the interior area 120 of the enclosure 108. Moreover, the inner wall 132 can assist in separating the channel 134, and the processed crop material flowing through the channel 134, from the interior area 120 of the enclosure 108 or other processed crop material within the interior area 120. Thus, compared to the interior area 120 of the enclosure 108, the inner wall 132 can at least assist in the bypass system 122 providing, within the channel 134, a generally cleaner environment than the interior area 120 of the enclosure 108 for the sensor 140 to capture, including detect, information indicative of the characteristics of processed crop material discharged from the threshing assembly 26, and, more specifically, from the separator section 44.

According to certain embodiments, the inner wall 132 can include, or otherwise at least partially define, one or more orifices or openings that provide one or more inlets 136 for the bypass system 122. The inlet(s) 136 can provide an opening for processed crop material released from the separator section 44 to flow into the bypass system 122, and, moreover, to flow into the channel 134 of the housing 124. Additionally, the inner wall 132 can also include, or otherwise at least partially define, one or more other orifices or openings that can provide one or more outlets 138 of the bypass system 122. The outlet(s) 138 can provide an opening for processed crop material to flow out of the channel 134, and thus exit the bypass system 122. According to certain embodiments, the outlet(s) 138 can be positioned at a location that is generally adjacent to the second end 158 of the bottom wall 128. Accordingly, to the extent the outer wall is sloped or inclined, as shown in by the exemplary embodiment shown in at least FIG. 6, at least some processed crop material flowing through the channel 134 can slide along the inclined or sloped bottom wall 128 and out of bypass system, 122 through the outlet 138.

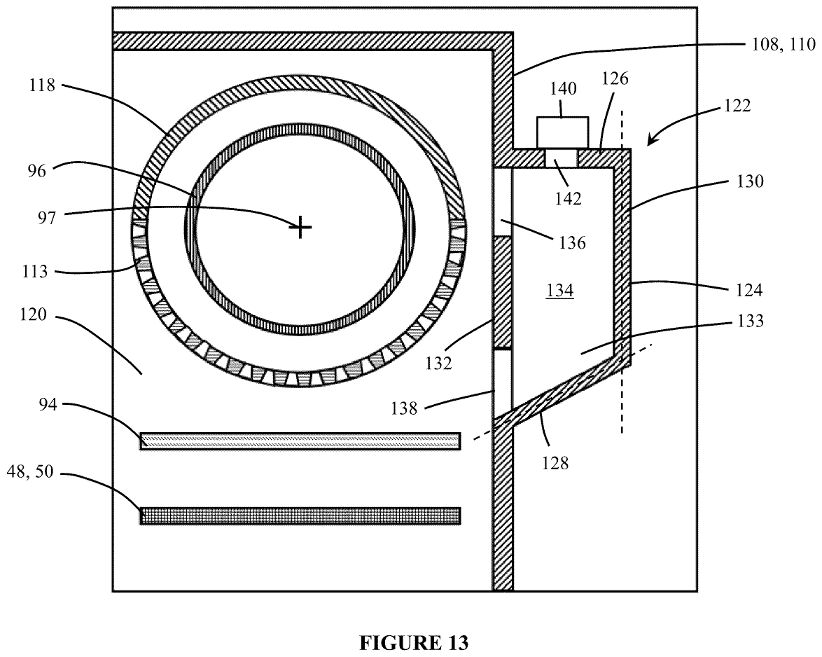

The location of the outlet 138 about the inner wall 132 or along the sidewall 110 of the enclosure 108 can vary. For example, according to certain embodiments, including embodiments in which either or both the first and second rotor assemblies 96, 98 rotate about longitudinal axes, rather than about transverse axes, the outlet 138 can be positioned such that processed crop material can be delivered from the bypass system 122 to the return pan 94, as shown, for example, in at least FIGS. 13 and 14. Alternatively, according to other embodiments, the outlet 138 can be positioned such that processed crop material that passes through the outlet 138 is delivered to the chaffer or sieve 95 that is positioned beneath at least the return pan 94, as shown in at least FIG. 6. Further, according to certain embodiments, the outlet 138 can be positioned such that processed crop material can be returned by the bypass system 122 to the interior area 120 of the enclosure 108, among other locations.

The bypass system 122 can also include a sensor 140, such as, for example, a contact or non-contact sensor that is configured to obtain information used to determine a composition or constitution of the processed crop material that flows through the channel 134 of the bypass system 122.

According to embodiments in which the sensor 140 is a noncontact sensor, the sensor 140 can be configured to capture one or more images, video, or video segments in a visible or non-visible light spectrum. For example, according to certain embodiments, the sensor 140 can be a camera that can capture information, including images or video, as well as combinations thereof, of the processed crop material flowing through the channel 134. Alternatively, the sensor 140 can be a receiver that can capture information in a non-visible light spectrum, including information obtained from one or more signals that had been emitted from a receiver or an associated emitter of the sensor 140.

According to certain embodiments in which the sensor 140 is a noncontact sensor, the sensor 140 can be embedded in, or positioned behind, the outer wall 130, among other surfaces of the bypass system 122. Such positioning of the sensor 140 can seek to accommodate the sensor 140 being able to capture information of the processed crop material flowing through the channel 134 while not being contacted by, or having minimal contact with, the processed crop material. Moreover, such positioning of the sensor 140 can prevent or minimize damage to the sensor 140 from direct strikes by at least certain types of debris, such as, for example, rocks, released from the separator section 44. Additionally, or alternatively, the optical sensor 140 can be positioned at a location at which, if such debris strikes the sensor 140, the velocity of the debris has been reduced since being released from the separator section 44.

According to certain embodiments, the sensor 140 can be positioned at a location relative to at least the inlet 136 such that minimal, if any, of the processed crop material that has entered the channel 134 that is captured in the captured information obtained by the sensor 140 is hitting, striking, rebounding, or bouncing off either or both the outer wall 130 and the inner wall 132 while within the field of view of the sensor 140. For example, the sensor 140 can be positioned in at least an attempt to have all, or a majority of, the processed crop material, at least within the field of view of the sensor 140, be currently free falling along the channel 134 without experiencing changes in trajectory from contact with the adjacent outer wall 130 or inner wall 132.

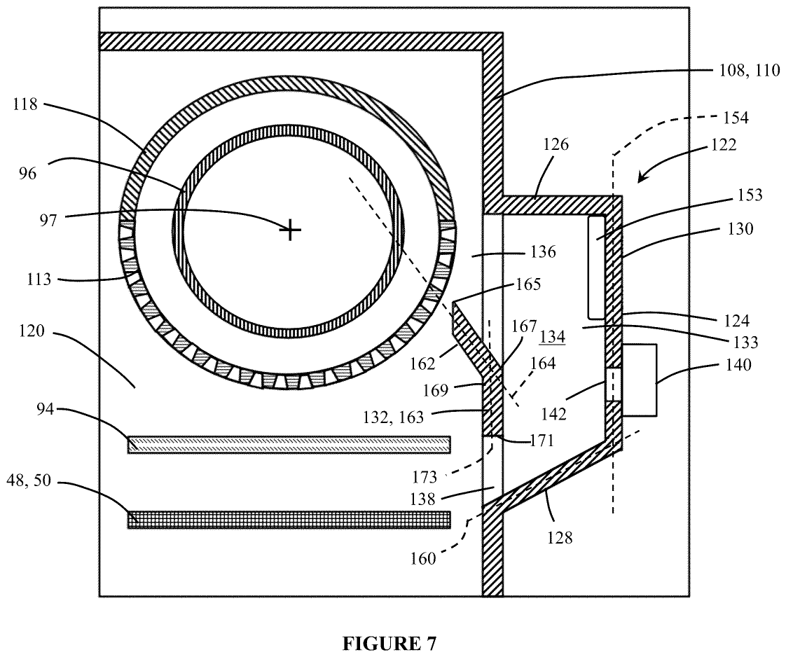

As seen in at least FIG. 7, according to certain embodiments, one or more walls 126, 128 130, 132, among other portions of the housing 126, that at least partially defines, or is otherwise adjacent to, the channel 134 can include, or be coupled to, one or more compliant bodies 153. The compliant body(ies) 153 can be configured to at least partially absorb an impact force associated with the compliant body 153 being stricken or otherwise hit by processed crop material, among other debris, that may be dispensed into the channel 134. For example, according to certain embodiments, the compliant body 153 can be an elastomeric material, or a collection of bristles, fibers, or wires, among other materials or configurations, that can at least partially deform, bend, or deflect by an impact force resulting from processed crop material, or other debris, hitting or striking the compliant body 153. For example, while FIG. 7 illustrates a compliant body 153 attached to at least a portion of the inner side of the outer wall 130, according to other embodiments, the compliant body 153 can be suspended from, or between, one or more walls 126, 128 130, 132 and into a portion of the channel 134. For example, according to certain embodiments, the compliant body 153 can be a curtain that downwardly extends from the top wall 126, among other locations, or one or more wires that extend in front of the outer wall 130 within the channel 134, among other configurations. Such absorption of at least a portion of the force associated with the processed crop material, or other debris, impacting the compliant body 153, can, at least relevant to direct impact with the corresponding wall 126, 128 130, 132 in the absence of the presence of the compliant body 153, prevent, or minimize, the extent or distance, the processed crop material or other debris travels in a vertical direction, a horizontal direction, or a combination thereof, away from the compliant body 153. For example, the absorption of such impact forces by the complaint body 153 can result in a reduction of a directional component, such as either or both a vertical component and a horizontal component, of the subsequent trajectory of at least the processed crop material as the processed crop material bounces off, or otherwise rebounds away from, the compliant body 153.

As illustrated, the bypass system 122 can include, or be communicatively coupled to, one or more controllers 144 having one or more processors 146 and one or more memory devices 148. The processors 146 can be configured to follow instructions, including control instructions contained with, or are part of, one or more of the memory devices 148, including, for example, a non-transitory machine-readable medium. While the controller 144 is shown in FIG. 6, such a feature is also applicable to at least the other bypass system 122 embodiments discussed herein, including the embodiments shown in at least FIGS. 7-15.

According to certain embodiments, the controller 144, including the associated processor(s) 146 can utilize information captured by the sensor 140 to derive information regarding the composition of the processed crop material passing through the bypass system 122. Such derived information can include an indication of a detected amount of crop (e.g., grain) or chaff or MOG, or a combination thereof, detected from analyzing the captured information. Further, such composition can be used to determine crop to MOG, including grain to chaff, ratio which, for example, among other types of derived information, can be used to assess the transfer function being used in connection with the information being provided by the impact sensor(s) 111. For example, one or more values, including weights or weighted values, of a transfer function currently being used to correlate information from the impact sensor(s) 111 with grain or crop loss can be at least partially based on an anticipated grain to chaff ratio. The grain to chaff ratio obtained by the controller 144 using the captured information provided by the sensor 140 can therefore be compared to the anticipated grain to chaff ratio used for the current transfer function in determining whether the anticipated grain to chaff ratio, and thus the transfer function, is to be updated. By updating, if necessary, the anticipated grain to chaff ratio in such a manner, the accuracy of the determinations made by the transfer function can be enhanced. Moreover, the configuration of the bypass system, 122, including with respect to either or both providing a cleaner environment and the state of the processed crop material when the captured information is obtained by the sensor 140, can improve the quality of information captured by the sensor 140, thereby improving the grain to chaff ratio derived by the controller 144 from such captured information. By providing more accurate information from the captured information, the evaluation, possible adjustment, and accuracy of resulting determinations made by the transfer function can be further improved.

The processors 146 can be embodied as any type of processor or other compute circuit capable of performing various tasks. In some embodiments, each processor 146 can be embodied as a single or multi-core processor, a microcontroller, or other processing or controlling circuit. Additionally, in some embodiments, each processor 146 can be embodied as, include, or be coupled to an FPGA, an application specific integrated circuit (ASIC), reconfigurable hardware or hardware circuitry, or other specialized hardware to facilitate performance of the functions described herein. In some embodiments still, each processor 146 can be embodied as a high-power processor, an accelerator co-processor, an FPGA, or a storage controller.

The memory device 148 can be of one or more types of non-transitory computer-readable media, such as a solid-state memory, electromagnetic memory, optical memory, or a combination thereof. Further, the memory device 148 can be volatile and/or nonvolatile. It should be appreciated that the memory device 148 can store information that is manipulated by the operating logic of processor 146, such as, for example, information representative of inputted signals in addition to or in lieu of storing programming instructions defining operating logic. Each memory device 148 can store various software and information used during operation of the bypass system 122, such as applications, programs, libraries, and drivers. Thus, the memory devices 148 can include information, including, but not limited to, algorithms and look-up tables, among other information, that can be used by the processor 146, including with respect to features corresponding adjustments in an operation of the agricultural machine 10, or one or more systems, subsystems, or assemblies of the agricultural machine 10. For example, the memory devices 148 can include information that, in response to determinations made by the controller 144 that are at least partially based on an evaluation of the captured information obtained by the sensor 140, can result in adjustments, or suggested adjustments that are outputted for the operator of the agricultural machine 10, in the operation in one or more of the threshing assembly 26, first rotor assembly 96, or second rotor assembly 98, as well as combinations thereof, among other aspects of the agricultural machine 10.

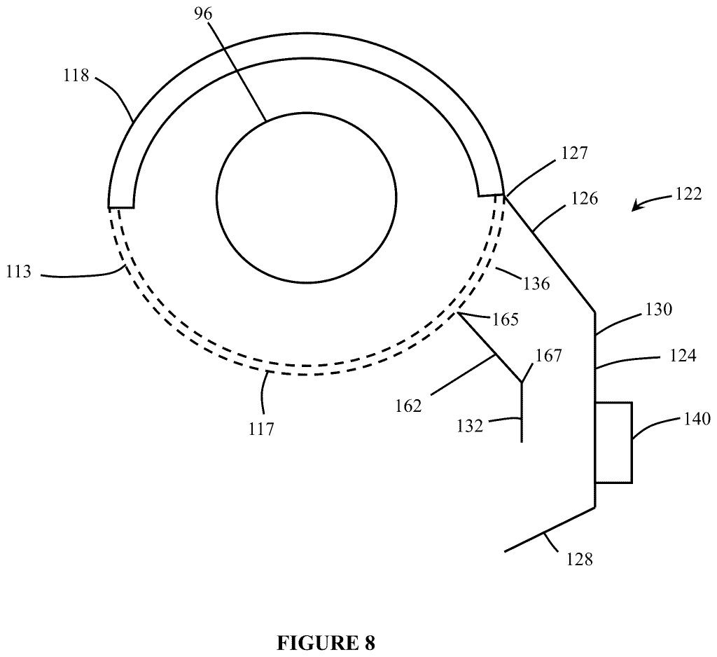

FIG. 7 illustrates a simplified sectional view of another exemplary embodiment of the bypass system 122 in which the inner wall 132 of the housing 108 of the bypass system 122 is, or includes, an arm portion 162 configured to facilitate an increase in the amount of processed crop material that flows into the channel 134 of the bypass system 122. The arm portion 162 can extend from a first end 165 to a second end 167 of the arm portion 162 along a third central axis 164, the third central axis 164 being both non-parallel and non-perpendicular to other portions, or adjacent portions of the adjacent, inner wall 132 of the enclosure 108. According to certain embodiments, the arm portion 162 can be configured to inwardly extend, relative to other portions of the inner wall 132, into the interior area 120 of the enclosure 108. For example, in the illustrated example shown in FIG. 7, the arm portion 162 is sloped away from an adjacent base portion 163 of the inner wall 132, the base portion 163 extending between the arm portion 162 and the outlet 138 of the bypass system 122 along a fourth central axis 173 that is non-parallel and non-perpendicular to the third central axis 164. Moreover, base portion 163 of the inner wall 132 can extend along the fourth central axis 173 between a first end 169 of the base portion 163, which can be adjacent to the arm portion 162, and a second end 171 of the base portion 164, which can be at the outlet 138. Such a configuration can include the third central axis 164 extending in a direction generally towards the adjacent rotor assembly 96, 98. For example, according to certain embodiments, the arm portion 162 can generally be sloped relative to either or both the base portion 163 and the outlet 138 in a direction at which the arm portion 162 extends into the interior area 120 of the enclosure 108 to provide the bypass system 122 with a basket, scoop, or funnel that can increase the amount of material dispensed from the separator section 44 within the interior area 120 that is directed into, or captured by, the bypass system 122, and, moreover, that flows along the channel 134. For example, the inward angle of the third central axis 164, and, moreover, the arm portion 162, can facilitate a redirection of processed crop material, thereby enhancing the efficiency of material collection by the bypass system 122 at least with respect to the amount of processed crop material that flows within the channel 134. Such an increase in volume of processed crop material flowing through the bypass system 122 can increase the amount of processed crop material detected by the sensor 140, which can thereby improve the accuracy of information derived by the controller 144 using at least the information provided by the sensor 140. Further, although at least an upper portion of the channel 134 is shown in at least FIG. 8 as being defined generally by the top wall 126 and the arm portion 162, that upper portion of the channel 134 can also be defined by sidewalls that can extend between the top wall 126 and arm portion 162 so as to generally surround the channel 134 at least at that upper portion of the channel 134.

As shown in FIG. 7, according to certain embodiments, the first end 165 of the arm portion 162 can be positioned in close proximity to, but not in contact with, an adjacent portion of the grate assembly 114, including a portion of the grate assembly 114 at, along, or around the separator section 44. Alternatively, as depicted in FIGS. 8-12, according to other embodiments, the arm portion 162, including the first end 165, can abut against or be coupled to an adjacent portion of the grate assembly 114 at, along, or around the separator section 44. Such physical contact, if not connection, between the arm portion 162 and the grate assembly 114 can, for example, increase the quantity of processed crop material that is captured to flow into channel 134 of the bypass system 122, as well as improve the consistency of the processed crop material entering the bypass system 122 in a manner that may not be as dependent on the speed of the rotor of the associated rotor assembly 96, 98 for the trajectory of processed crop material dispensed through the grates 113.

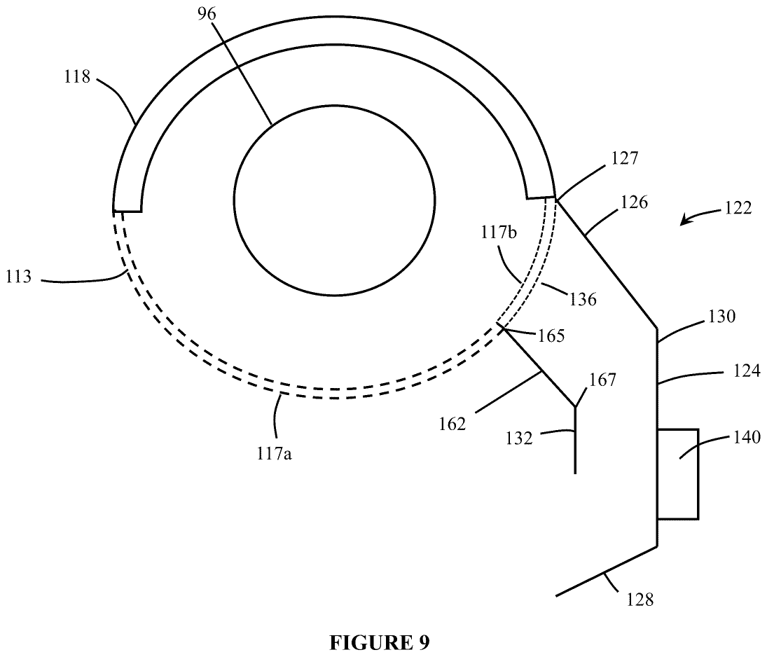

In FIG. 8, the openings 117 within the grates 113 are depicted as being generally uniform in size throughout the grate assembly 114, thereby providing a consistent pattern for material passage. In FIG. 9, however, the openings 117 in the grates 113 exhibit variation at least in terms of size, and thus with respect to the size of processed crop material that can pass through the openings 117. Moreover, according to the embodiment shown in FIG. 9, the grate(s) 113 can include a first plurality of openings 117a and a second plurality of openings 117b. The second plurality of openings 117b, unlike the first plurality of openings 117a, are positioned adjacent to the inlet 136 of the bypass system 122. Thus, for example, the second plurality of openings 117b can extend in a region of the grate 113 that is adjacent to the inlet 136, which in this embodiment is the region between the first end 165 of the arm portion 162 and an adjacent first end of the assembly cover 118 that is adjacent to the inlet 136. According to such an embodiment, the first plurality of openings 117a can extend about other portions of the grate 113 that are not adjacent to the inlet 136, such as the area between the first end 165 of the arm portion 162 and the second opposing end of the assembly cover 118, as illustrated in FIG. 9.

With such a configuration, the openings 117 of the second set 117b can have at least one dimension, such as either or both a height and a width, that differs from the corresponding dimension of the openings 117 in the first set 117a. Thus, for example, the size of the openings 117 of the second plurality of openings 117b can be smaller or larger than the corresponding size of the openings 117 of the first plurality of openings 117a. Moreover, in the embodiment shown in FIG. 9, the openings 117 of the second plurality of openings 117b are smaller than the openings 117 of the first plurality of openings 117a. Thus, compared to the larger openings 117 of the first plurality of openings 117a, the openings 117 of the second plurality of openings 117b can be less permissible with respect to the size of processed crop material that can pass through the openings 117 of the second plurality of openings 117b. Conversely, according to embodiments in which the openings 117 of the first plurality of openings 117a are smaller than the openings 117 of the second plurality of openings 117b, the openings 117 of the second plurality of openings 117b can be more permissible in terms of the size of processed crop material that can pass through the openings 117 of the second plurality of openings 117b. Alternatively, according to other embodiments, the grate may include openings 117 along the first plurality of openings 117a, but no grate 113 or be discontinued in the area adjacent to the inlet 136 so as to provide an open area between the inlet 136 and the separator section 44. Further, while the foregoing is discussed with respect to the inlet 136 being adjacent to the second plurality of openings 117b, according to other embodiments the inlet 136 can instead be adjacent to the first plurality of openings 117a.

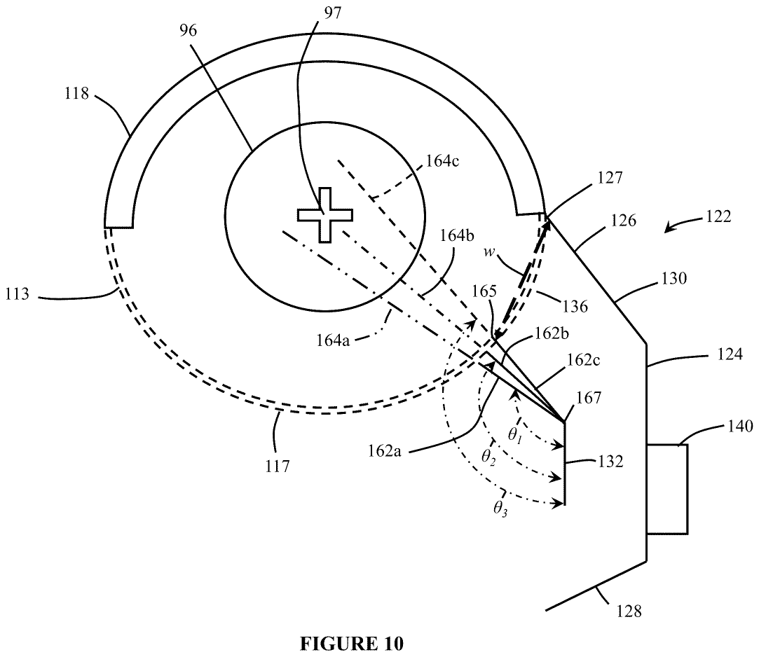

FIG. 10 illustrates various angular orientations of at least the arm portion 162a, 162b, 162c relative to either or both the grate 113 and the adjacent rotor assembly 96, 98. For example, according to certain embodiments, the second end 167 of the arm portion 162 can be positioned, and an arm angle, in this example a first arm angle (θ₁), at which either or both the arm portion 162a and the third central axis 164a extends be configured, such that the arm portion 162a or third central axis 164a, if extended, is aligned to extend to a location that is vertically below the corresponding first or second longitudinal axis 97, 99 of the adjacent first or second rotor assembly 96, 98. Such a configuration can assist in increasing, including widening, the size of, or across, the inlet 136 to the bypass system 122 (as generally indicated by “w” in FIG. 10), which can thereby further assist in increasing the volume of processed crop material that enters into the channel 134. Alternatively, according to other embodiments, the arm angle can be a second arm angle (θ₂) configured for the arm portion 162b and the third central axis 164b, if continued, to be aligned to extend through the corresponding first or second longitudinal axis 97, 99 of the adjacent first or second rotor assembly 96, 98. According to such an embodiment, the width (w) across the inlet 136 can be smaller than the corresponding width (w) of the arm portion 162a associated with the first arm angle (θ₁). According to another embodiment, the arm angle can be a third arm angle (θ₃) configured for the arm portion 162c and the third central axis 164b, if continued, to be aligned to extend above the corresponding first or second longitudinal axis 97, 99 of the adjacent first or second rotor assembly 96, 98. By using such a third arm angle (θ₃), width (w) across the inlet 136 can be smaller than the width attained when using the first and second arm angles (θ₁, θ₂). Such variances in widths (w) across the inlet 136 can impact at least the amount of processed crop material received into the channel 134 of the bypass system 122 and the flow characteristics of the processed crop material received into the channel 134. For example, by providing a steeper arm angle, the configuration of the channel 134 can be enhanced in a manner that can prevent the formation of blockages by processed crop material, or other debris, within the channel 134. Moreover, such differences can impact the trajectories 112a, 112b of processed crop material released from the separator section 44 that can be received by the bypass system 122.

While FIG. 10 illustrates three angular orientations of the arm portion 162a, 162b, 162c, according to certain embodiments, the bypass system 122 can be configured such that the angular orientation of the arm portion 162 is adjustable to at least one of the illustrated configurations shown in FIG. 10. For example, according to certain environments, the bypass system 122 can be configured such that the arm portion 162 is adjustable between a position associated with one of the first, second, or third arm angles (θ₁, θ₂, θ₃) and another one of the first, second, or third arm angles (θ₁, θ₂, θ₃), as well as locations therebetween. For example, according to certain embodiments, the arm portion 162 can be coupled to an actuator that can be selectively actuated to displace the arm portion 162 to an angular orientation associated with either the first or second arm angles (θ₁, θ₃), as well as angular orientations therebetween. Such adjustments in the angular orientation of the arm portion 162 can be triggered in a variety of different manners, including in response to the volume of processed crop material passing through the channel 134 not satisfying, or exceeding, a predetermined volume threshold, among other triggers, including, for example, crop type or crop condition, such as, for example, moisture content.

While FIG. 10 depicts an exemplary arm portion 162 aligned along a particular arm angle (θ₁, θ₂, θ₃), according to other embodiments, the arm portion 162 can have a plurality of sections or members that may, or may not, be each generally aligned along the same arm angles (θ₁, θ₂, θ₃). For example, according to certain embodiments, while a first arm segment of the arm portion 162 that generally defines at least a portion of the inlet 136 can be aligned along a first arm angle (θ₁), a second arm segment of the arm portion 162 downstream of the first arm segment can be aligned along a steeper second arm angle (θ₂). Additionally, with such an example, the steeper second arm angle (θ₂) of the second arm segment of the arm portion 162 can be configured to at least assist in preventing the formation of a blockage from processed crop material within the channel 130. Further, with such an embodiment, the arm portion 162 can include one or more other arm segments that may, or may not, be aligned along the first or second arm angles (θ₁, θ₂), or may be aligned along a different arm angle.

According to other embodiments, the arm angle (θ₁, θ₂, θ₃) or third axis 164 (FIG. 7) for the arm portion 162 can extend in a manner that the distance between the arm portion 162 and the opposing top wall 126 increases as the arm portion 162 extends away from the first end 165 of the arm portion 162, including as the arm portion 162 moves away from the inlet 136. Such an orientation of the arm portion 162, and resulting increase in size of the channel 130 along at least the arm portion 162 downstream of the first end 165 of the arm portion 162 or inlet 136 can provide the channel 130 with a configuration that can minimize the potential for a formation of a blockage created by processed crop material, or other debris, within the channel 130 downstream of the inlet 136.

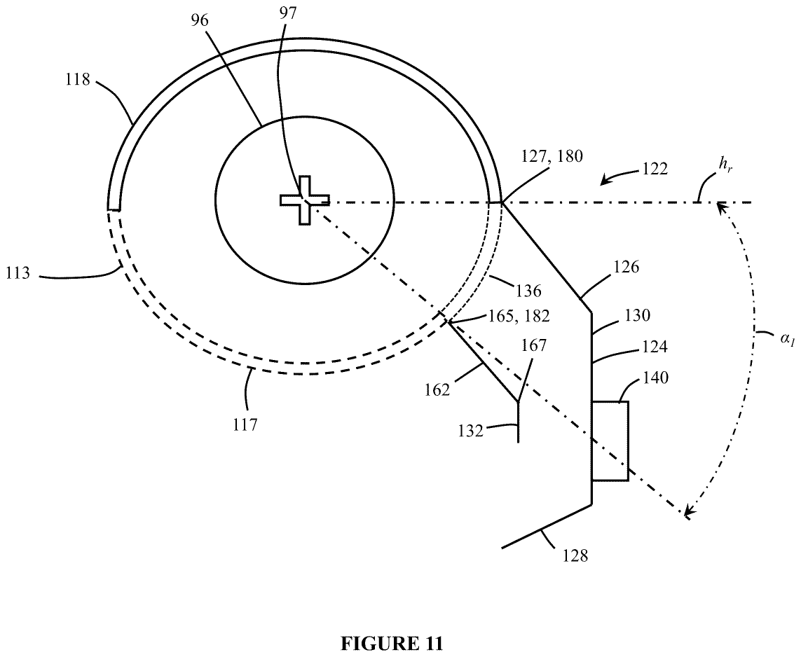

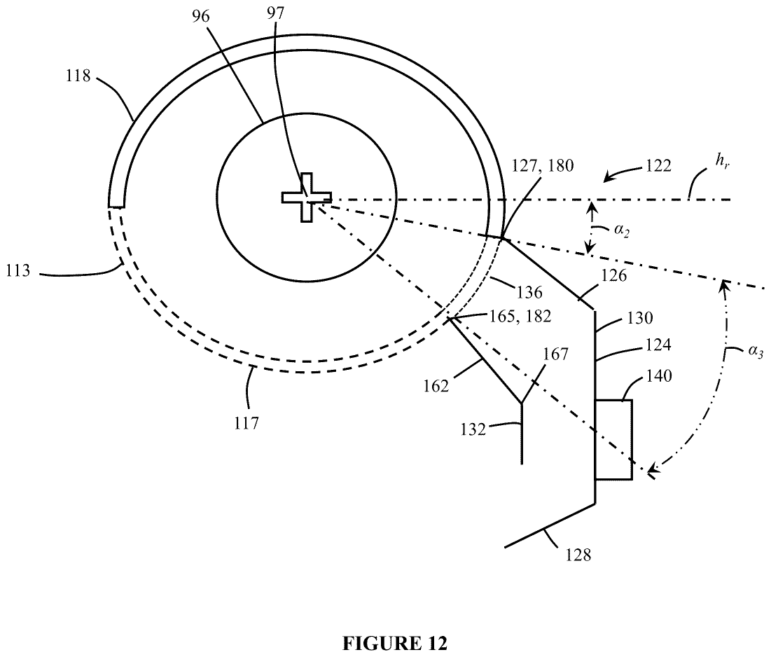

FIGS. 11 and 12 illustrate simplified side views of exemplary embodiments of the bypass system 122 demonstrating different sizes and positions of the inlet 136 of the bypass system 122 relative to both a longitudinal axis 97, 99 of the adjacent rotor assembly 96, 98 and an adjacent arc-shaped portion of a grate 113 of the grate assembly 114, 116. As shown, according to certain embodiments, a first end 180 of inlet 136 to the bypass system 122 can, according to certain embodiments, be at, or positioned along, with a horizontal axis (“hᵣ”) that generally extends through the longitudinal axis 97, 99 of the adjacent rotor assembly 96, 98, or a central location of the grate assembly 114, 116. According to certain embodiments, the horizontal axis (“hᵣ”) can be generally parallel to the ground surface upon which the agricultural machine 10 is positioned. Further, according to certain embodiments, the first end 180 of the inlet 136 can be at, or around, the first end 127 of the top wall 126, which can, for example, also be positioned along the horizontal axis (hᵣ). A second end 182 of the inlet 136 can be at a variety of angular positions relative to the first end 180 of the inlet 136, and, moreover, about the arcuate shaped grate 113. For example, according to certain embodiments, the first and second ends 180, 182 of the inlet 136 can be separated by an inlet angle (as generally indicated by “α₁” in FIG. 11) of about 30 degrees to about 60 degrees. Alternatively, as shown in FIG. 12, according to other embodiments, the first end 180 of the inlet 136 can be angularly offset from the horizontal axis (hᵣ) by an offset angle (as generally indicated by “α₂” in FIG. 11). According to certain embodiments, if the second end 182 of the inlet 136 is at an angle from the horizontal axis hᵣ) of about 30 degrees to about 60 degrees, the inlet angle (as generally indicated by “α₃” in FIG. 12) can be reduced by the offset angle (α₂), which can thereby reduce the width of size of the inlet 136 between the first and second ends 180, 182 of the inlet 136. Alternatively, according to other embodiments, the separation between the first and second end 180, 182 of the inlet 136, or inlet angle (α₃) can remain about 30 degrees to about 60 degrees, and the offset angle (α₂) can offset or shift the location of the inlet 136 relative to at least the horizontal axis (hᵣ).

FIG. 13 illustrates a simplified sectional view of an additional exemplary embodiment of the bypass system 122 that is generally similar to the bypass system 122 shown in at least FIG. 6 but in which the sensor 140 is mounted to a top wall 126 of the bypass system 122 and the outlet 138 is positioned to release processed crop material onto the return pan 94. By positioning the sensor 140 at the top wall 126, the sensor 140 can capture information regarding processed crop material as the processed crop material passes through the inlet 136, but has not necessarily downwardly traveled through the channel 134 in the region between the opposing outer and inner walls 130, 132. Such positioning of the sensor 140, and the generally downwardly directed field of view of the sensor 140, can assist, for example, in capturing information regarding the processed crop material received by the bypass system 122 prior to the processed crop material striking, or rebounding from contact with, either of the outer and inner walls 130, 132 while within the channel 134. Such positioning of the sensor 140 can thus assist in preventing at least some, but not necessarily all, of the processed grain material rebounding back into the field of view of sensor 140 in a manner that could result in duplicative detection of that material with other materials, which may adversely impact the accuracy of the captured information obtained by the sensor 140.

FIG. 14 illustrates a simplified sectional view of a further exemplary embodiment of the bypass system 122 that is similar to the embodiment of the bypass system 122 shown in FIG. 6 but in which the sensor 140 is mounted along a portion of a flow path for the processed crop material within the channel 134. For example, as shown in FIG. 14, according to certain embodiments, the sensor 140 can be positioned about the bottom wall 128 of the housing 124, among other locations within the channel 134. By being positioned within a portion of the flow path, the sensor 140 can thus be contacted by at least some of the processed crop material within the channel 134. Therefore, in the embodiment shown in FIG. 14, the sensor 140 can be a contact sensor, such as, for example, an impact sensor, including, but not limited to, a piezoelectric sensing element, among others. According to such an embodiment, the sensor 140 can detect when crop, such as a seed, within the flow of processed crop material hits or strikes the impact sensor 140. As with the impact sensors 111 discussed above, identification of detected hits or strikes with the sensor 140 over a time period can be used by the controller 144, via use of a transfer function, to determine, include estimate, an amount of crop (e.g., grain) being dispensed from the separator section 44 in connection with determining the crop loss from the separator section 44.

Alternatively, according to other embodiments, the sensor 140 shown in FIG. 14 can be an optical or imaging sensor, including a camera, that is positioned to capture information regarding processed crop material flowing in a generally downward direction toward the sensor 140. Optionally, according to such an embodiment, a transparent protective cover 141, which may or may not be part of a protective housing, that can shield the sensor 140 from direct contact with the processed crop material while generally not interfering with the sensor 140 capturing information of processed crop material that is within the field of view of the sensor 140.

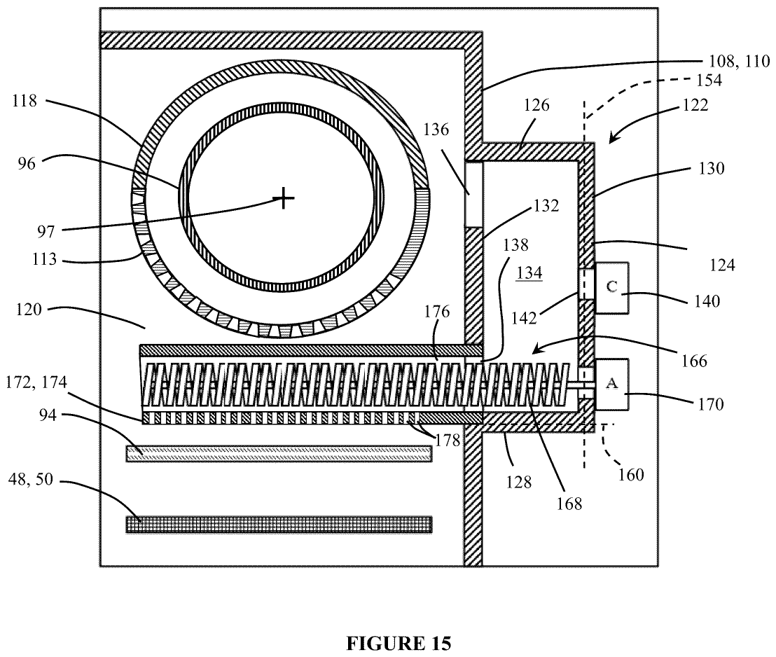

FIG. 15 illustrates a simplified sectional view of another exemplary embodiment of the bypass system 122 that includes a conveyance system 166 for conveying processed crop material through, from the outlet 138, of the bypass system 122. The conveyance system 166, which can be positioned downstream of the sensor 140, can include a conveyor 168 that is configured to impart a force that moves the processed crop material from, or out of, the bypass system 122. A variety of different types of devices can be used as the conveyor 168, and the conveyor 168 can be operated or powered in a variety of manners. For example, according to the illustrated embodiment, the conveyor 168 is an auger that is powered via an actuator 170, such as a motor. According to such an embodiment, selective operation of the actuator 170, such as activation or deactivation of the actuator 170 in response to one or more signals generated by the controller 144, can power movement of the conveyor 168, such as power rotation of the auger, in a manner that provides the force to initiate and maintain a movement of the processed crop material at least out of the bypass system 122.

According to certain embodiments, the conveyance system 166 can further include a conduit 172 having a wall 174 that defines a passageway 176 through which the conveyor 168 displaces processed crop material away from the bypass system 122. According to certain embodiments, the conduit 172 extends across at least a portion of the return pan 94, as shown in FIG. 15, or across the sieve 48, 50, among other locations of the cleaning shoe 92. The wall 174 of the conduit 172 can further include a plurality of perforations 178 through which processed crop material can be released from the passageway 176 and toward the adjacent return pan 94 or sieve 48, 50. Further, the conduit 172 and perforations 178 can be positioned and sized to promote a generally even distribution of the released processed crop material across the adjacent return pan 94 or sieve 48, 50. Further, while the conduit 172 shown in FIG. 15 is depicted as extending in a generally horizontal direction, the conduit 172 can extend in a variety of other, or additional, directions, including being angled in either or both the fore-aft direction toward a rear or front end of the return pan 94 or sieve 48, 50 and toward a side wall of the adjacent return pan 94 or sieve 48, 50, as well as various combinations thereof, among other angular orientations.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. A bypass system for receiving a processed crop material from a separator section of a threshing assembly of an agricultural machine, the bypass system comprising:
a housing including
an inlet;
an outlet; and
a channel, the inlet and the outlet being at opposing ends of the channel, the inlet configured to provide an opening to receive the processed crop material from the separator section and deliver the processed crop material into the channel, the channel configured to accommodate a passage of the processed crop material through the bypass system;
a sensor configured to capture information of at least a portion of the processed crop material within the channel; and
a conveyor positioned downstream of the sensor, the conveyor configured to provide a force that facilitates a movement of the processed crop material located in the channel through the outlet.

2. The bypass system of claim 1, wherein the outlet is positioned to deliver the processed crop material outputted from the bypass system to a return pan of a cleaning shoe, the return pan being positioned between a rotor assembly of the threshing assembly and a sieve of the cleaning shoe.

3. The bypass system of claim 1, wherein the channel is at least partially separated from an interior area of an enclosure housing the separator section.

4. The bypass system of claim 1, wherein the housing further comprises an arm portion, the arm portion being configured to be adjacent to a grate of a grate assembly of the separator section, the arm portion defining at least a portion of the inlet.

5. The bypass system of claim 1, wherein the housing further comprises an arm portion, the arm portion being configured to be coupled to, or in contact with, a grate of a grate assembly of the separator section, the arm portion defining at least a portion of the inlet.

6. The bypass system of claim 5, further including the grate, the grate having a first plurality of openings and a second plurality of openings, the first plurality of openings and the second plurality of openings sized to accommodate a discharge of at least a portion of the processed crop material from the separator section through the first plurality of openings and the second plurality of openings, the first plurality of openings being different in size than the second plurality of openings, and wherein the inlet is positioned to receive the processed crop material from one of the first plurality of openings and the second plurality of openings.

7. The bypass system of claim 5, further including the grate, the grate having a first plurality of openings and an open area, the open area being devoid of a plurality of individual openings in the grate, the inlet being positioned to receive the processed crop material through the open area.

8. The bypass system of claim 1, further comprising a conduit, wherein the conveyor is configured move the processed crop material through a passageway of the conduit, the conduit having a plurality of perforations configured for passage of the processed crop material out from the passageway.

9. The bypass system of claim 1, wherein the sensor includes a contact sensor that is positioned along at least a portion of a pathway for the processed crop material within the channel.

10. The bypass system of claim 1, wherein the sensor includes a non-contact sensor that is positioned along at least a portion of a pathway for the processed crop material within the channel, the sensor being positioned behind an at least partially transparent protective cover.

11. The bypass system of claim 1, wherein the conveyor includes an auger.

12. A bypass system for receiving a processed crop material from a separator section of a threshing assembly of an agricultural machine, the bypass system comprising:
a housing including:
an inlet;
an outlet; and
a channel, the inlet and the outlet being at opposing ends of the channel, the inlet configured to provide an opening to receive the processed crop material from the separator section, the inlet being at least partially defined by an arm portion of the housing that is positioned against a grate of the separator section, the channel configured to accommodate a passage of the processed crop material through the bypass system; and
a sensor configured to capture information of at least a portion of the processed crop material within the channel.

13. The bypass system of claim 12, further including the grate, the grate having a first plurality of openings and a second plurality of openings, the first plurality of openings and the second plurality of openings sized to accommodate a discharge of at least a portion of the processed crop material from the separator section through the first plurality of openings and the second plurality of openings, the first plurality of openings having a size that is different than a corresponding size of the second plurality of openings, and wherein the inlet is positioned to receive the processed crop material from one of the first plurality of openings and the second plurality of openings.

14. The bypass system of claim 12, further including the grate, the grate having a first plurality of openings and an open area, the open area being devoid of a plurality of individual openings, the inlet being positioned to receive the processed crop material through the open area.

15. The bypass system of claim 12, wherein the arm portion is inwardly inclined along a central longitudinal axis that extends through a central axis of the grate.

16. A bypass system for receiving a processed crop material from a separator section of a threshing assembly of an agricultural machine, the bypass system comprising:
a housing including:
an inlet;
an outlet; and
a channel, the inlet and the outlet being at opposing ends of the channel, the inlet configured to provide an opening to receive the processed crop material from the separator section and deliver the processed crop material into the channel, the channel configured to accommodate a passage of the processed crop material through the bypass system;
a sensor configured to capture information of at least a portion of the processed crop material within the channel; and
a compliant body positioned within the channel, the compliant body configured to absorb at least a portion of an impact force from an impact of at least a portion of the processed crop material received into the channel with the compliant body in a manner that, relative to the impact instead being with the housing, reduces at least a directional component of a subsequent travel of the portion of the processed crop material after the impact with the compliant body.

17. The bypass system of claim 16, wherein the compliant body comprises an elastomeric material, a collection of bristles, a plurality of fibers, or one or more wires.

18. The bypass system of claim 16, wherein the compliant body is mounted to at least one wall of the housing.

19. The bypass system of claim 16, wherein the compliant body is suspended within the channel.

20. The bypass system of claim 16, further comprising a conveyor positioned downstream of the sensor, the conveyor configured to provide a force that facilitates a movement of the processed crop material located in the channel through the outlet.
